(19) United States
(12) Patent Application Publication
(10) Pub. No.: US 2026/0030131 A1
(43) Pub. Date: Jan. 29, 2026

(54) METHOD AND SYSTEM FOR CALCULATING DOMAIN RELEVANCE SCORES FOR RESPONSES GENERATED BY LARGE LANGUAGE MODELS

(71) Applicant: HCL Technologies Limited, New Delhi (IN)

(72) Inventors: Sasikumar Shanmugam, Bengaluru (IN); Yogesh Gupta, Noida (IN); Harikrishna C Warrier, Bengaluru (IN)

(73) Assignee: HCL Technologies Limited, (omitted)

(21) Appl. No.: 19/277,387

(22) Filed: Jul. 23, 2025

(30) Foreign Application Priority Data
Jul. 23, 2024 (IN) 202411056117

(51) Int. Cl. G06F 11/34; G06F 16/334

(52) U.S. Cl. CPC G06F 11/3414; G06F 16/334

(57) ABSTRACT

A method for calculating domain relevance scores for responses generated by LLMs is disclosed. The method includes receiving a response generated by LLM corresponding to user query. The user query is associated with a domain. The method further includes splitting the response into a plurality of response chunks using a splitting technique. The method further includes generating a plurality of response vector embeddings based on the plurality of response chunks using at least one sentence transformer. The method further includes computing a plurality of cosine distances between the plurality of response vector embeddings and a corresponding plurality of training data vector embeddings, wherein the plurality of training data vector embeddings corresponds to domain-specific training data of the LLM. The method further includes calculating a domain relevance score corresponding to the response, based on a sum of the plurality of cosine distances and a number of the plurality of chunks.

### TECHNICAL FIELD

This disclosure generally relates to Large Language Models (LLMs) and more particularly to a method and a system for calculating domain relevance scores for responses generated by LLMs.

### Background

Large Language Models (LLMs) are gaining increasing popularity in various industries (such as healthcare, legal, finance, entertainment, education, and the like) owing to their unprecedented performance in various applications. LLMs are trained using huge datasets and are capable of providing responses to user queries. Therefore, LLMs are tipped to replace search engines in the future as users prefer a direct solution to user queries rather than a list of links to go through and research. As a result, evaluation of LLM-generated responses is critical to determine accuracy of such responses. In some scenarios, evaluation of relevance of the LLM-generated responses to the user queries is done manually based on user feedback to the LLM-generated responses. However, manual evaluation of generated response is time-consuming, is non-scalable, suffers from bias, is inconsistent, requires domain specific experts, and has limited coverage.

In the present state of art, metrics for evaluation of relevance of LLM-generated responses mainly focus on factual or context relevance of the LLM-generated responses. However, these metrics fail to provide a measure of relevance of the LLM-generated responses for a given domain. There is, therefore, a need in the present state of art for techniques to provide a measure of closeness of the LLM-generated responses to the domain.

The present invention is directed to overcome one or more limitations stated above or any limitations associated with the known arts.

### SUMMARY

In one embodiment, a method for calculating domain relevance scores for responses generated by Large Language Models (LLMs) is disclosed. In one example, the method may include receiving a response generated by an LLM corresponding to a user query. It should be noted that the user query may be associated with a domain. The method may further include splitting the response into a plurality of response chunks using a splitting technique. The method may further include generating a plurality of response vector embeddings based on the plurality of response chunks using at least one sentence transformer. The method may further include computing a plurality of cosine distances between the plurality of response vector embeddings and a corresponding plurality of training data vector embeddings. It should be noted that the plurality of training data vector embeddings may correspond to domain-specific training data of the LLM. The method may further include calculating a domain relevance score corresponding to the response, based on a sum of the plurality of cosine distances and a number of the plurality of response chunks.

In another embodiment, a system for calculating domain relevance scores for responses generated by Large Language Models (LLMs) is disclosed. In one example, the system may include a processor and a memory communicatively coupled to the processor. The memory may store processor-executable instructions, which, on execution, may cause the processor to receive a response generated by an LLM corresponding to a user query. It should be noted that the user query may be associated with a domain. The processor-executable instructions, on execution, may further cause the processor to split the response into a plurality of response chunks using a splitting technique. The processor-executable instructions, on execution, may further cause the processor to generate a plurality of response vector embeddings based on the plurality of response chunks using at least one sentence transformer. The processor-executable instructions, on execution, may further cause the processor to compute a plurality of cosine distances between the plurality of response vector embeddings and a corresponding plurality of training data vector embeddings. It should be noted that the plurality of training data vector embeddings may correspond to domain-specific training data of the LLM. The processor-executable instructions, on execution, may further cause the processor to calculate a domain relevance score corresponding to the response, based on a sum of the plurality of cosine distances and a number of the plurality of response chunks.

In yet another embodiment, a non-transitory computer-readable medium storing computer-executable instruction for calculating domain relevance scores for responses generated by Large Language Models (LLMs) is disclosed. The stored instructions, when executed by a processor, may cause the processor to perform operations including receiving response generated by an LLM corresponding to a user query. It should be noted that the user query may be associated with a domain. The operations may further include splitting the response into a plurality of response chunks using a splitting technique. The operations may further include generating a plurality of response vector embeddings based on the plurality of response chunks using at least one sentence transformer. The operations may further include computing a plurality of cosine distances between the plurality of response vector embeddings and a corresponding plurality of training data vector embeddings. It should be noted that the plurality of training data vector embeddings may correspond to domain-specific training data of the LLM. The operations may further include calculating a domain relevance score corresponding to the response, based on a sum of the plurality of cosine distances and a number of the plurality of response chunks.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for calculating domain relevance scores for responses generated by Large Language Models (LLMs), in accordance with some embodiments of the present disclosure.

FIG. 2 illustrates a functional block diagram of a computing device configured to calculate domain relevance scores for responses generated by LLMs, in accordance with some embodiments of the present disclosure.

FIG. 3 illustrates a flow diagram of an exemplary process for generating and storing training data vector embeddings, in accordance with some embodiments of the present disclosure.

FIG. 4 illustrates a flow diagram of an exemplary process for calculating domain relevance scores for responses generated by LLMs, in accordance with some embodiments of the present disclosure.

FIG. 5 illustrates a flow diagram of an exemplary control logic for calculating domain relevance scores for responses generated by LLMs, in accordance with some embodiments of the present disclosure.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

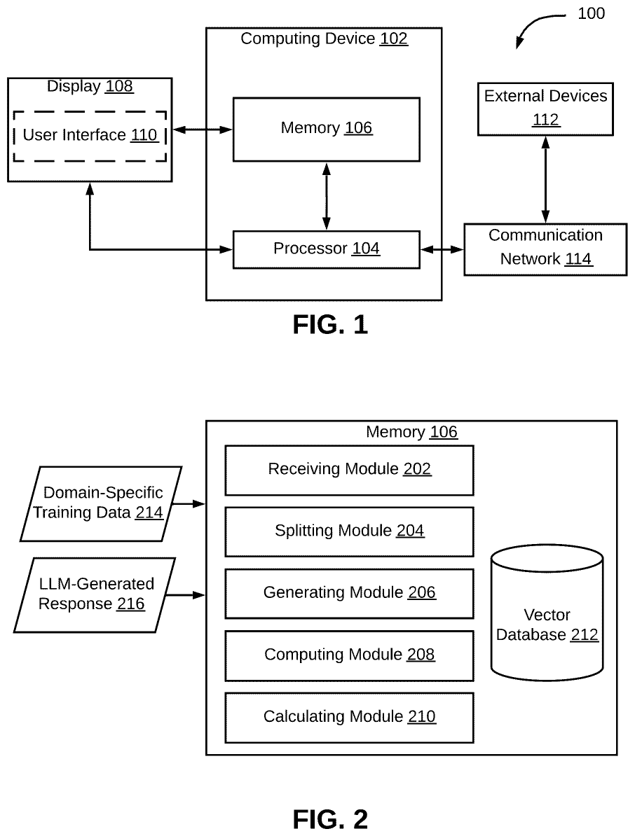

Referring now to FIG. 1 an exemplary system 100 for calculating domain relevance scores for responses generated by Large Language Models (LLMs) is illustrated, in accordance with some embodiments of the present disclosure. The system 100 may include a computing device 102. The computing device 102 may be, for example, but may not be limited to, server, desktop, laptop, notebook, netbook, tablet, smartphone, mobile phone, or any other computing device, in accordance with some embodiments of the present disclosure. In some embodiments, the computing device 102 may calculate domain relevance scores for responses generated by an LLM based on a comparison of the responses with corresponding domain-specific training data of the LLM. The domain relevance score may provide a measure of relevance of an LLM-generated response to a given domain.

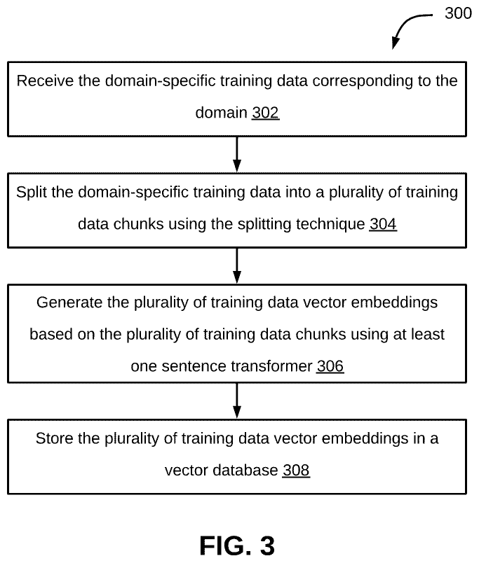

As will be described in greater detail in conjunction with FIGS. 2-5, in order to calculate domain relevance scores for responses generated by LLMs, the computing device 102 may receive a response generated by an LLM corresponding to a user query. It should be noted that the user query may be associated with a domain. The computing device 102 may further split the response into a plurality of response chunks using a splitting technique. The computing device 102 may further generate a plurality of response vector embeddings based on the plurality of response chunks using at least one sentence transformer. The computing device 102 may further compute a plurality of cosine distances between the plurality of response vector embeddings and a corresponding plurality of training data vector embeddings. It should be noted that the plurality of training data vector embeddings may correspond to domain-specific training data of the LLM. The computing device 102 may further calculate a domain relevance score corresponding to the response, based on a sum of the plurality of cosine distances and a number of the plurality of response chunks.

In some embodiments, the computing device 102 may include one or more processors 104 and a memory 106. Further, the memory 106 may store instructions that, when executed by the one or more processors 104, cause the one or more processors 104 to calculate domain relevance scores for responses generated by LLMs, in accordance with aspects of the present disclosure. The memory 106 may also store various data (for example, plurality of response vector embeddings, the domain-specific training data, plurality of training data vector embeddings, domain relevance score, and the like) that may be captured, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 100 may further include a display 108. The system 100 may interact with a user interface 110 accessible via the display 108. The system 100 may also include one or more external devices 112. In some embodiments, the computing device 102 may interact with the one or more external devices 112 over a communication network 114 for sending or receiving various data. The communication network 114 may include, for example, but may not be limited to, a wireless fidelity (Wi-Fi) network, a light fidelity (Li-Fi) network, a local area network (LAN), a wide area network (WAN), a metropolitan area network (MAN), a satellite network, the internet, a fiber optic network, a coaxial cable network, an infrared (IR) network, a radio frequency (RF) network, and a combination thereof. The external devices 112 may include, but may not be limited to, server, laptop, netbook, notebook, smartphone, mobile phone, tablet, or any other computing device.

Referring now to FIG. 2, a functional block diagram of the computing device 102 is illustrated, in accordance with some embodiments of the present disclosure. FIG. 2 is explained in conjunction with FIG. 1. The computing device 102 may calculate domain relevance scores for responses generated by an LLM. The memory 106 may include a receiving module 202, a splitting module 204, a generating module 206, a computing module 208, and a calculating module 210.

The LLM may be trained or fine-tuned using domain-specific training data 214 to generate responses corresponding to a domain-specific user query (i.e., a user query associated with a domain). The domain-specific training data 214 may include data corresponding to a domain (for example, but not limited to, medical domain, education domain, healthcare domain, finance domain, entertainment domain, sports domain, topography domain, and legal domain). In some embodiments, the LLM may be trained from scratch using the domain-specific training data 214. In other embodiments, the LLM may be pre-trained using generic training data and may then be fine-tuned using the domain-specific training data 214. By way of an example, the LLM may be, but may not be limited to, a Generative Pre-trained Transformer (GPT), Gemini, a Large Language Model Meta AI (LLAMA), a Bidirectional Encoder Representations from Transformer (BERT), or the like. The domain-specific training data 214 may be in a format, for example, but not limited to, Portable Document Format (PDF), Comma-Separated Values (CSV) files, HTML, word document (DOC and DOCX), Text file (TXT), Microsoft Excel spreadsheet files (XLS and XLSX), or the like.

Further, the receiving module 202 may receive the domain-specific training data 214 corresponding to the domain. Upon receiving the domain-specific training data 214, the splitting module 204 may split the domain-specific training data 214 into a plurality of training data chunks using a splitting technique. Text in the domain-specific training data 214 may be broken down into the plurality of training data chunks to store all tokens in a vector database easily. By way of an example, the splitting technique may be, but may not be limited to, a fixed length splitting technique or a sentence splitting technique. By way of an example, the text “Large Language Models are machine learning models that can be comprehend and generate human language text”, is split into the plurality of training data chunks by using the sentence splitting technique. The plurality of training data chunks may be ‘Large’, ‘Language’, ‘Models’, ‘are’, ‘machine’, ‘learning’, ‘models’, ‘that’, ‘can’, ‘be’, ‘comprehend’, ‘and’, ‘generate’, ‘human’, ‘language’, and ‘text’. By way of another example, consider a scenario where the user may use the fixed length splitting technique to split the text in the domain-specific training data 214, the text is split into strings of a fixed predefined length. Thus, if the fixed predefined length is set as 5 by the user, the plurality of training data chunks may be Large’, ‘Lang’, ‘uage’, ‘Model’, ‘s are’, ‘mach’, ‘ine l’, ‘earni’, ‘ng mo’, ‘dels’, ‘that’, ‘can b’′e com′, ‘prehe’, ‘nd an’, ‘d gen’, ‘erate’, ‘huma’, ‘n lan’, ‘guage’, and ‘text’.

Further, the generating module 206 may generate a plurality of training data vector embeddings based on the plurality of training data chunks using at least one sentence transformer. The at least one sentence transformer may be, but may not be limited to, Natural Language Processing (NLP), Universal Sentence Encoder (USE), and ROBERTa.

In some embodiments, each of the plurality of training data vector embeddings may be processed using a quantization technique. The quantization technique may include, for example, but may not be limited to, a Product quantization (PQ), and a Binary quantization (BQ). The quantization may reduce the size (or dimensions) of each of the training data vector embeddings which may help in reducing computing time, reducing memory footprint, reducing deployment cost, improving speeds, and providing faster results. In another embodiment, the plurality of training data vector embeddings may be further processed without any quantization. By way of an example, each of the plurality of training data vector embeddings are quantized to reduce into integer 8 bits. In some embodiments, the plurality of training data vector embeddings may be represented in a floating-point notation.

Further, the plurality of training data vector embeddings may be stored in the vector database 212 by the generating module 206 for further processing. Some examples of the vector database 212 may include, for example, but may not be limited to, Chroma, Pinecone, Weaviate, Faiss, Qdrant, and Pgvector.

Upon storing the plurality of training data vector embeddings of the training data of the LLM in the vector database 212, the computing device 102 may be ready to determine the domain relevance scores of the responses generated by that LLM to user queries.

A user may provide a user query to the LLM. The LLM may then generate an LLM-generated response 216 to the user query. The user query may be a textual query. The user query is associated with a specific domain. Similarly, the LLM-generated response 216 may be a textual response. The receiving module 202 of the computing device 102 may receive the LLM-generated response 216 in textual format. Further, the receiving module 202 may send the LLM-generated response 216 to the splitting module 204.

The splitting module 204 may split the LLM-generated response 216 into a plurality of response chunks using the splitting technique. It should be noted that the splitting technique used for splitting the response may be same as the splitting technique used for splitting the domain-specific training data 214. Further, the splitting module 204 may send the plurality of response chunks to the generating module 206.

The generating module 206 may generate a plurality of response vector embeddings based on the plurality of response chunks using at least one sentence transformer. By way of an example, the sentence transformer may be, but may not be limited to, NLP, USE, and the ROBERTa. It should be noted that the sentence transformer used for generating the plurality of response vector embeddings may be same as the sentence transformer used for generating the plurality of training data vector embeddings. Further, the generating module 206 may send the plurality of response vector embeddings to the generating module 206.

In some embodiments, each of the plurality of response vector embeddings may be quantized using the quantization technique. By way of an example, each of the response vector embeddings are quantized to reduce into integer 8 bits. In some embodiments, the response vector embeddings may be represented in a floating-point notation.

Further, upon generation of the plurality of response vector embeddings, the computing module 208 may retrieve the plurality of training data vector embeddings from the vector database 212. Further, the computing module 208 may compute a plurality of cosine distances between the plurality of response vector embeddings and the plurality of training data vector embeddings. By way of an example, the generating module 206 may generate a response vector embedding (A) and a response vector embedding (B). Further, the generating module 206 may have generated a training data vector embedding (C) and a training data vector embedding (D) that may correspond to the response vector embedding (A) and the response vector embedding (B), respectively. The computing module 208 may determine the cosine distance between the response vector embedding (A) and the training data vector embedding (C). Similarly, the computing module 208 may determine the cosine distance between the response vector embedding (B) and the training data vector embedding (D). Further, the computing module 208 may send the plurality of cosine distances to the calculating module 210.

The calculating module 210 may calculate a domain relevance score corresponding to the response, based on a sum of the plurality of cosine distances and a number of the plurality of response chunks. The domain relevance score (represented as “DoReS”) may be calculated using equation (1):

$$DoReS = \frac{Number of chunks - Sum of cosine distance}{Number of chunks} * 100 \qquad ( 1 )$$

Further, the computing device 102 may render the domain relevance score for the response generated by the LLM on a Graphical User Interface (GUI) on a user device. The user device may be, for example, but not limited to, server, laptop, netbook, notebook, smartphone, mobile phone, tablet, or any other computing device.

It should be noted that all such aforementioned modules 202-210 may be represented as a single module or a combination of different modules. Further, as will be appreciated by those skilled in the art, each of the modules 202-210 may reside, in whole or in parts, on one device or multiple devices in communication with each other. In some embodiments, each of the modules 202-210 may be implemented as dedicated hardware circuit comprising custom application-specific integrated circuit (ASIC) or gate arrays, off-the-shelf semiconductors such as logic chips, transistors, or other discrete components. Each of the modules 202-210 may also be implemented in a programmable hardware device such as a field programmable gate array (FPGA), programmable array logic, programmable logic device, and so forth. Alternatively, each of the modules 202-210 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module, and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for calculating domain relevance scores for responses generated by LLMs. For example, the exemplary system 100 and the associated computing device 102, may calculate domain relevance scores for responses generated by LLMs by the processes discussed herein. In particular, as will be appreciated by those of ordinary skill in the art, control logic and/or automated routines for performing the techniques and steps described herein may be implemented by the system 100 and the associated computing device 102, either by hardware, software, or combinations of hardware and software. For example, suitable code may be accessed and executed by the one or more processors on the system 100 to perform some or all of the techniques described herein. Similarly, application specific integrated circuits (ASICs) configured to perform some, or all of the processes described herein may be included in the one or more processors on the system 100.

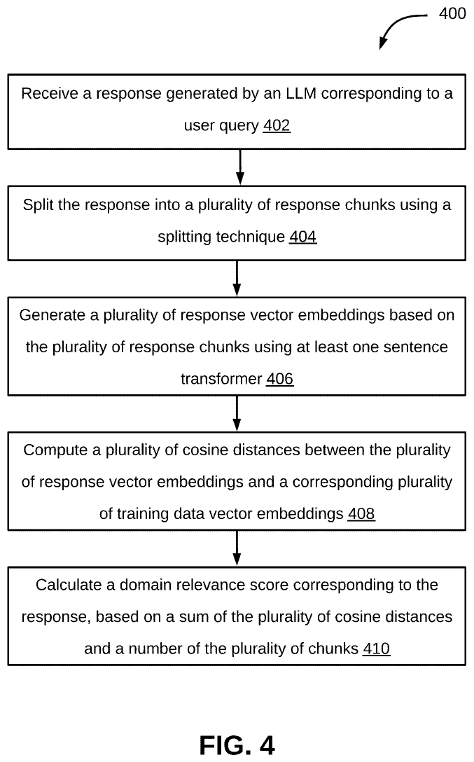

Referring now to FIG. 3, a process 300 for generating and storing a training data vector embeddings is illustrated via a flow chart, in accordance with some embodiments of the present disclosure. FIG. 3 is explained in conjunction with FIGS. 1 and 2. The process 300 may be implemented by the computing device 102 of the system 100. The process 300 includes receiving, by the receiving module 202, the domain-specific training data (such as the domain-specific training data 214) corresponding to a domain, at step 302. Some examples of the domain may include, but may not be limited to, healthcare domain, finance domain, education domain, entertainment domain, agriculture domain, and topography domain. The domain-specific training data may be used to fine-tune or train the LLM to generate response corresponding to a domain-specific user query (i.e., a user query associated with the domain). Thus, the LLM may be pre-trained with the domain-specific training data or fine-tuned with the domain-specific training data to generate domain-specific responses to the user queries.

Further, the process 300 includes splitting, by the splitting module 204, the domain-specific training data into a plurality of training data chunks using a splitting technique, at step 304. The splitting technique may be, for example, but may not be limited to, a fixed length splitting technique or a sentence splitting technique.

Further, the process 300 includes generating, by the generating module 206, a plurality of training data vector embeddings based on the plurality of training data chunks using at least one sentence transformer, at step 306.

In an optional embodiment, once the plurality of training data vector embeddings is generated, each of the plurality of training data vector embeddings may be processed via a quantization technique as per user requirement.

Further, the process 300 includes storing, by the generating module 206, the plurality of training data vector embeddings in a vector database (such as the vector database 212), at step 308.

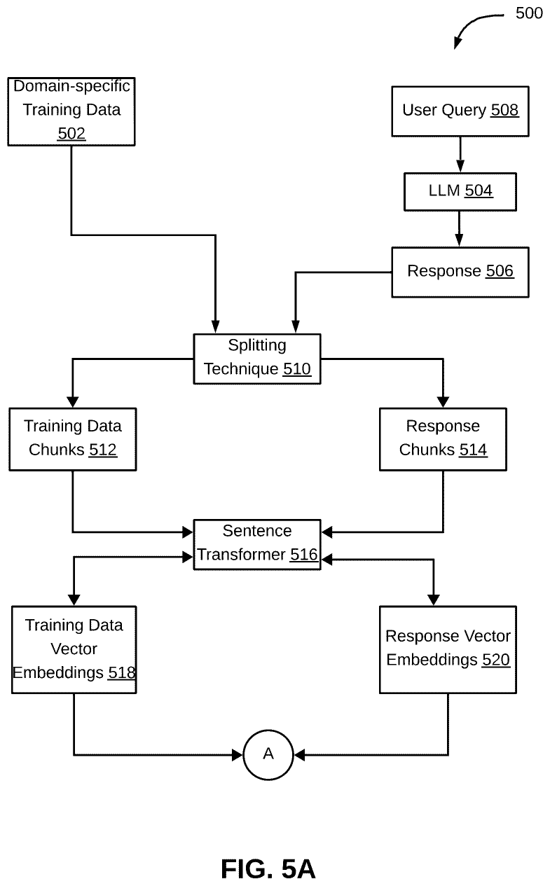

Referring now to FIG. 4, a process 400 for calculating domain relevance scores for responses generated by LLMs is illustrated via a flow chart, in accordance with some embodiments of the present disclosure. FIG. 4 is explained in conjunction with FIGS. 1, 2, and 3. The process 400 may be implemented by the computing device 102 of the system 100. In an embodiment, the process 400 may be implemented in continuation with the process 300. The process 400 includes receiving, by the receiving module 202, a response generated by an LLM corresponding to a user query, at step 402. It should be noted that the user query is associated with a domain. Upon receiving the user query associated with the domain, the LLM may be configured to generate the responses.

Further, the process 400 includes splitting, by the splitting module 204, the response into a plurality of response chunks using a splitting technique, at step 404. In an embodiment, the splitting technique used for splitting the response at the step 404 of the process 400 may be same as the splitting technique used for splitting the domain-specific training data at the step 304 of the process 300.

Further, the process 400 includes generating, by the generating module 206, a plurality of response vector embeddings based on the plurality of response chunks using at least one sentence transformer, at step 406. The sentence transformer may include, for example, may not be limited to, a Natural Language Processing (NLP), Universal Sentence Encoder, and ROBERTa.

In some embodiments, the process 400 includes processing each of the plurality of response vector embeddings to quantize using a quantization technique. The quantization technique may include, for example, but may not be limited to, a Product quantization (PQ), and a Binary quantization (BQ). The quantization may be configured to reduce the size of each of the training data vector embeddings which helps to reduce the computing time, memory footprint, deployment cost, improve speeds, and provide faster results. In some another embodiment, the plurality of training data vector embeddings may be further processed without any quantization.

The plurality of training data vector embeddings (generated and stored by the process 300) may be retrieved by the computing module 208 from the vector database upon generation of the plurality of response vector embeddings by the generating module 206. Further, the process 400 includes computing, by the computing module 208, a cosine distance between the plurality of response vector embeddings and a corresponding plurality of training data vector embeddings, at step 408. It should be noted that the plurality of training data vector embeddings corresponds to domain-specific training data of the LLM.

Further, the process 400 calculating, by the calculating module 210, a domain relevance score corresponding to the response, based on a sum of the plurality of cosine distances and a number of the plurality of response chunks, at step 410. The domain relevance score may be calculated using the equation (1).

Further, the process 400 may include rendering the domain relevance score on a user device. The user device may include, for example, but may not be limited to, server, laptop, netbook, notebook, smartphone, mobile phone, tablet, or any other computing device.

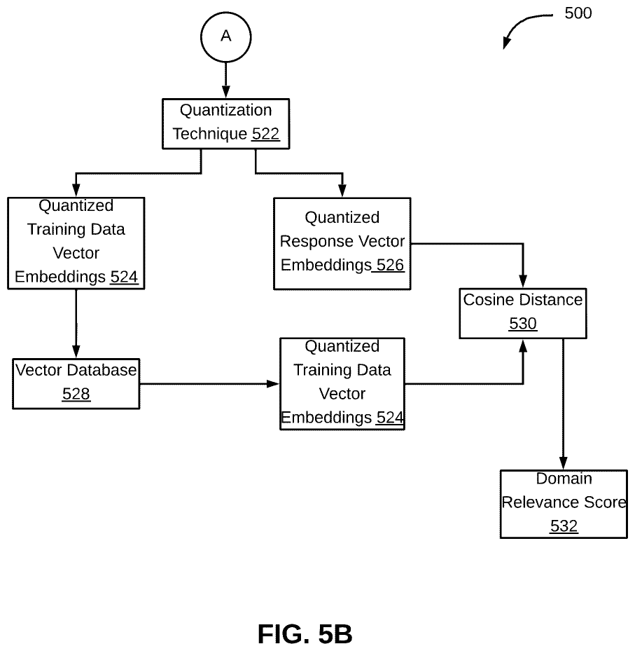

Referring now to FIG. 5, an exemplary control logic 500 for calculating domain relevance scores for responses generated by LLMs is illustrated via a flow chart, in accordance with some embodiments of the present disclosure. FIG. 5 is explained in conjunction with FIGS. 1-4. Initially, the receiving module 202 may be configured to receive domain-specific training data 502 corresponding to the domain. The domain-specific training data 502 may be analogous to the domain-specific training data 214. The domain-specific training data 502 may be used to fine-tune an LLM 504. Further, the receiving module 202 may receive a response 506 generated by the LLM 504 corresponding to a user query 508. The user query 508 may be associated with the domain.

Upon receiving the response 506, the splitting module 204 may split the domain-specific training data 502 and the response 506 into a plurality of training data chunks 512 and a plurality of response chunks 514, respectively, using a splitting technique 510. The splitting technique 510 may be a fixed length splitting technique or a sentence splitting technique.

Further, the generating module 206 may generate a plurality of training data vector embeddings 518 and a plurality of response vector embeddings 520 based on the plurality of training data chunks 512 and the plurality of response chunks 514, respectively, by using a sentence transformer 516. The sentence transformer 516 may be based on NLP, ROBERTa, or USE.

Further, the plurality of training data vector embeddings 518 and the plurality of response vector embeddings 520 may be quantized using a quantization technique 522 to obtain a plurality of quantized training data vector embeddings 524 and a plurality of quantized response vector embeddings 526. In some embodiments, the training data vector embeddings 518 and the response vector embeddings 520 may be quantized into an integer 8. In some another embodiment, the training data vector embeddings 518 and the response vector embeddings 520 may be further processed without quantization. In other words, with quantization is an optional step that is based on user requirements.

Further, the plurality of quantized training data vector embeddings 524 may be stored in a vector database 528 (analogous to the vector database 212). Further, the plurality of quantized training data vector embeddings 524 may be retrieved from the vector database 528 upon generating the plurality of quantized response vector embeddings 526. Further, the computing module 208 may compute a plurality of cosine distances 530 between the plurality of quantized response vector embeddings 526 and the corresponding plurality of quantized training data vector embeddings 524.

Once the cosine distances 530 are computed, then the calculating module 210 may calculate a domain relevance score corresponding to the response, based on a sum of the plurality of cosine distances and a number of the plurality of response chunks. The domain relevance score may be calculated by using the equation (1).

Further, the domain relevance score 532 may be rendered on a user device. The domain relevance score 532 may provide a measure of how relevant the response generated by the LLM is to the domain.

By way of an example, table 1 below represents the domain relevance score of some exemplary responses generated by an LLM with quantization or without quantization.

TABLE 1
Domain relevance scores of responses generated
by an LLM with or without quantization.

| | | 512 Seq | | 512 Seq |
|---|---|---|---|---|
| | | Len + | 512 Seq | Len + |
| | 512 Seq | Sentence | Len + | Fixed |
| | Len + | Split + | Fixed | Len + |
| | Sentence | Quantizer | Len + | Quantizer |
| | Split + | (int8) + | Vector | (int8) + |
| Prediction Text | Vector DB | Vector DB | DB | Vector DB |
| Q: What is AION? | 82.5 | 82.8 | 83.8 | 84.1 |
| Based on the provided context, I | | | | |
| can explain what AION is. | | | | |
| AION stands for Artificial | | | | |
| Intelligence ON, which is an AI life | | | | |
| cycle management platform used | | | | |
| for solving real-world problems | | | | |
| using machine learning. AION | | | | |
| provides a less-code/no-code | | | | |
| approach to users, allowing them | | | | |
| to train and deploy machine | | | | |
| learning models without any | | | | |
| coding knowledge. It includes | | | | |
| various sub-processes such as | | | | |
| AutoML, MLOPs, MLaC, and | | | | |
| Explainability. These sub- | | | | |
| processes are automated, and | | | | |
| AION generates the best | | | | |
| deployment model after analyzing | | | | |
| the input data and problem | | | | |
| statement. | | | | |
| Q: Write in detail about MLLite | 79.5 | 79.8 | 81.5 | 82.1 |
| feature in AION. List the input | | | | |
| model formats that can be | | | | |
| converted to ONNX. | | | | |
| Sure! Here's what I could gather | | | | |
| from the given text regarding the | | | | |
| MLLite feature in | | | | |
| AION: | | | | |
| MLLite feature in AION allows | | | | |
| users to convert their trained | | | | |
| models into different formats such | | | | |
| as ONNX, TFLite, and | | | | |
| Sagemaker. The main advantage | | | | |
| of this feature is that it enables | | | | |
| users to consume these | | | | |
| optimized models for predictions | | | | |
| without having to retrain them. | | | | |
| Input Model Formats that can be | | | | |
| converted to ONNX include: | | | | |
| Keras | | | | |
| Sklearn | | | | |
| TensorFlow | | | | |
| Light GBM | | | | |
| XGBoost | | | | |
| LibSVM | | | | |
| CoreML | | | | |
| Q: Is there Incremental learning in | 83.5 | 83.8 | 76.2 | 76.2 |
| AION? If so what are the steps to | | | | |
| create an incremental model? | | | | |
| Yes, there is incremental learning | | | | |
| in AION. To create an incremental | | | | |
| model follow the below-mentioned | | | | |
| steps: | | | | |
| Step 2: Click online learning tab. | | | | |
| Step 3: Select the Online | | | | |
| Learning (Beta) or Distributed | | | | |
| learning (Beta) checkbox for | | | | |
| Incremental Learning. | | | | |
| Step 4: Click next icon to proceed | | | | |
| to advanced configuration tab. | | | | |
| Q: Give the python command for | 87 | 87.3 | 76.3 | 76.6 |
| enabling CORS in AION | | | | |
| I don't know the answer to this | | | | |
| question as I cannot provide | | | | |
| information about the specific | | | | |
| settings and configurations of | | | | |
| AION, as well as their impact on | | | | |
| the model's performance. | | | | |
| However, according to the | | | | |
| documentation provided, users | | | | |
| can enable CORS using the | | | | |
| following command: | | | | |
| python aion_service.py ip 0.0.0.0 -p | | | | |
| 80 -cors “http://localhost:5000” | | | | |
| Q: How can we do text labelling | 79.5 | 79.9 | 82.5 | 82.7 |
| with AION? Give the API URL for | | | | |
| model monitoring? | | | | |
| Based on the provided context, I | | | | |
| can answer the question as | | | | |
| follows: | | | | |
| To perform text labelling with | | | | |
| AION, follow these steps: | | | | |
| Step 1: Go to Utilities > Text Data | | | | |
| Labelling. | | | | |
| Step 2: Upload the text data in | | | | |
| CSV format. | | | | |
| Step 3: Select relevant features | | | | |
| and click Next. | | | | |
| Step 4: Generate predictions by | | | | |
| clicking Predictions tab. | | | | |
| The predicted labels are | | | | |
| displayed under Predicted Labels | | | | |
| section. | | | | |
| For example, if the input text is | | | | |
| “This is a sample text”, the | | | | |
| predicted label would be | | | | |
| “positive”. | | | | |
| API URL for Model Monitoring: | | | | |
| To monitor the performance of the | | | | |
| model, users can use the API | | | | |
| endpoint/monitoring/model- | | | | |
| performance. This API returns the | | | | |
| summary statistics of the model's | | | | |
| performance along with the | | | | |
| confusion matrix. | | | | |
| Example: | | | | |
| curl -X POST | | | | |
| http://localhost:8080/monitoring/m | | | | |
| odel-performance -H ‘Content- | | | | |
| Type: application/json’ -d | | | | |
| {“data”:[“This is a sample | | | | |
| text”],“label”:[“positive”]}' | | | | |
| Average DoReS Score | 82.4 | 82.72 | 80.06 | 80.34 |
| Sum of Predict Times (Secs) | 1.4 | 1.07 | 0.95 | 0.48 |
| Embed Time (Secs) | 66.8 | 59.9 | 29.9 | 16.1 |
| Embed Size (KB) | 1256.4 | 314.1 | 64.5 | 16.1 |
| Sentence Transformer Size (GB) | 0.13 | 0.13 | 0.13 | 0.13 |
| Embed Dimension | 384 | 384 | 384 | 384 |
| Sequence Length | 512 | 512 | 512 | 512 |

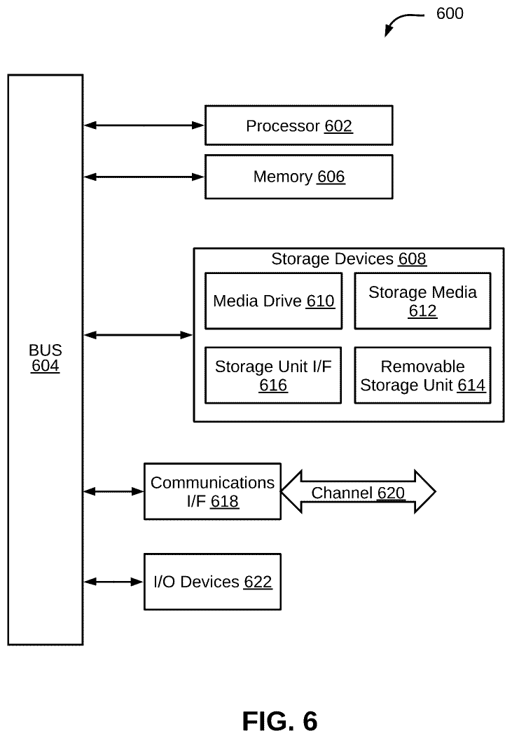

The disclosed methods and systems may be implemented on a conventional or a general-purpose computer system, such as a personal computer (PC) or server computer. Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 602 that may be implemented using a general or special purpose processing engine such as, for example, a microprocessor, microcontroller, or other control logic. In this example, the processor 602 is connected to a bus 604 or other communication medium. In some embodiments, the processor 602 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during execution of instructions to be executed by the processor 602. The computing system 600 may likewise include a read only memory (“ROM”) or other static storage device coupled to bus 604 for storing static information and instructions for the processor 602.

The computing system 600 may also include storage devices 608, which may include, for example, a media drive 610, a cloud based storage, a network storage, and a removable storage interface. The media drive 610 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 612 may include, for example, a hard disk, magnetic tape, flash drive, or other fixed or removable medium that is read by and written to by the media drive 610. As these examples illustrate, the storage media 612 may include a computer-readable storage medium having stored there in particular computer software or data.

In alternative embodiments, the storage devices 608 may include other similar instrumentalities for allowing computer programs or other instructions or data to be loaded into the computing system 600. Such instrumentalities may include, for example, a removable storage unit 614 and a storage unit interface616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro-USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or other communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, vibrating motor, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

Various embodiments provide method and system for calculating domain relevance scores for responses generated by LLMs. The disclosed method and system may receive a response generated by an LLM corresponding to a user query. The user query is associated with a domain. Further, the disclosed method and system may split the response into a plurality of response chunks using a splitting technique. Further, the disclosed method and system may generate a plurality of response vector embeddings based on the plurality of response chunks using at least one sentence transformer. Moreover, the disclosed method and system may compute a plurality of cosine distances between the plurality of response vector embeddings and a corresponding plurality of training data vector embeddings. The plurality of training data vector embeddings corresponds to domain-specific training data of the LLM. Thereafter, the disclosed method and system may calculate a domain relevance score corresponding to the response, based on a sum of the plurality of cosine distances and a number of the plurality of response chunks.

Thus, the disclosed method and system try to overcome the traditional method of evaluating responses generated by the LLM. The method and system calculate domain relevance scores which provide how close the response generated by the LLM is to the domain (or how relevant the response is to the domain). The domain relevance score may be used to gauge the LLM learnability for the given domain. The method and system may be used a check prior to publishing the LLM either to the production or to the public.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only.

What is claimed is:

1. A method for calculating domain relevance scores for responses generated by Large Language Models (LLMs), the method comprising:
receiving, by a computing device, a response generated by an LLM corresponding to a user query, wherein the user query is associated with a domain;
splitting, by the computing device, the response into a plurality of response chunks using a splitting technique;
generating, by the computing device, a plurality of response vector embeddings based on the plurality of response chunks using at least one sentence transformer;
computing, by the computing device, a plurality of cosine distances between the plurality of response vector embeddings and a corresponding plurality of training data vector embeddings, wherein the plurality of training data vector embeddings corresponds to domain-specific training data of the LLM; and
calculating, by the computing device, a domain relevance score corresponding to the response, based on a sum of the plurality of cosine distances and a number of the plurality of response chunks.

2. The method of claim 1, wherein the splitting technique is one of a fixed length splitting technique or a sentence splitting technique.

3. The method of claim 1, further comprising:
receiving, by the computing device, the domain-specific training data corresponding to the domain;
splitting, by the computing device, the domain-specific training data into a plurality of training data chunks using the splitting technique;
generating, by the computing device, the plurality of training data vector embeddings based on the plurality of training data chunks using at least one sentence transformer; and
storing, by the computing device, the plurality of training data vector embeddings in a vector database.

4. The method of claim 1, further comprising processing, by the computing device, each of the response vector embeddings and the training data vector embeddings using a quantization technique.

5. The method of claim 3, further comprising retrieving, by the computing device, the plurality of training data vector embeddings from the vector database upon generating the plurality of response vector embeddings.

6. The method of claim 1, further comprising rendering, by the computing device, the domain relevance score for the response generated by the LLM on a user device.

7. A system for calculating domain relevance scores for responses generated by Large Language Models (LLMs), the system comprising:
a processor; and
a memory communicatively coupled to the processor, wherein the memory stores processor executable instructions, which, on execution, causes the processor to:
receive a response generated by an LLM corresponding to a user query, wherein the user query is associated with a domain;
split the response into a plurality of response chunks using a splitting technique;
generate a plurality of response vector embeddings based on the plurality of response chunks using at least one sentence transformer;
compute a plurality of cosine distances between the plurality of response vector embeddings and a corresponding plurality of training data vector embeddings, wherein the plurality of training data vector embeddings corresponds to domain-specific training data of the LLM; and
calculate a domain relevance score corresponding to the response, based on a sum of the plurality of cosine distances and a number of the plurality of response chunks.

8. The system of claim 7, wherein the splitting technique is one of a fixed length splitting technique or a sentence splitting technique.

9. The system of claim 7, wherein the processor executable instructions further cause the processor to:
receive the domain-specific training data corresponding to the domain;
split the domain-specific training data into a plurality of training data chunks using the splitting technique;
generate the plurality of training data vector embeddings based on the plurality of training data chunks using at least one sentence transformer; and
store the plurality of training data vector embeddings in a vector database.

10. The system of claim 7, wherein the processor executable instructions further cause the processor to process each of the response vector embeddings and the training data vector embeddings using a quantization technique.

11. The system of claim 9, wherein the processor executable instructions further cause the processor to retrieve the plurality of training data vector embeddings from the vector database upon generating the plurality of response vector embeddings.

12. The system of claim 7, the processor executable instructions further cause the processor to render the domain relevance score for the response generated by the LLM on a user device.

13. A non-transitory computer-readable medium storing computer-executable instructions for calculating domain relevance scores for responses generated by Large Language Models (LLMs), the stored instructions, when executed by a processor, cause the processor to perform operations comprises:
receiving a response generated by an LLM corresponding to a user query, wherein the user query is associated with a domain;
splitting the response into a plurality of response chunks using a splitting technique;
generating a plurality of response vector embeddings based on the plurality of response chunks using at least one sentence transformer;
computing a plurality of cosine distances between the plurality of response vector embeddings and a corresponding plurality of training data vector embeddings, wherein the plurality of training data vector embeddings corresponds to domain-specific training data of the LLM; and
calculating a domain relevance score corresponding to the response, based on a sum of the plurality of cosine distances and a number of the plurality of response chunks.
